(19) United States
(12) Patent Application Publication
(10) Pub. No.: US 2014/0036373 A1
(43) Pub. Date: Feb. 6, 2014

(54) LENS SUBSTRATE AND ELECTROOPTIC DEVICE INCLUDING LENS SUBSTRATE

(71) Applicant: Seiko Epson Corporation, Tokyo (JP)

(72) Inventor: Tsuyoshi Sunagawa, Suwa-shi (JP)

(73) Assignee: Seiko Epson Corporation, Tokyo (JP)

(21) Appl. No.: 13/947,312

(22) Filed: Jul. 22, 2013

(30) Foreign Application Priority Data
Aug. 1, 2012 (JP) 2012-170880

(51) Int. Cl. G02B 3/00

(52) U.S. Cl. CPC G02B 3/0012
USPC 359/620

(57) ABSTRACT

A lens substrate which includes: a plurality of concave portions which define each of curved surfaces of a plurality of lenses; a non-silicon-based resin which is formed between neighboring lenses among the plurality of lenses; and a silicon-based resin which is formed so as to cover the non-silicon-based resin, and the plurality of lenses.

### BACKGROUND

1. Technical Field

The present invention relates to a lens substrate and an electrooptic device including the lens substrate.

2. Related Art

As one of electrooptic devices, for example, there is a liquid crystal device of a thin film transistor (TFT) active matrix drive type which is used as a light bulb in a liquid crystal projector. As such a liquid crystal device, there is known a liquid crystal device in which a minute microlens is provided at a position corresponding to each pixel of the liquid crystal device in order to increase a utilization efficiency of light.

A microlens substrate which includes a microlens has a structure in which neoceram glass and the microlens are integrally formed by performing an etching process in the neoceram glass. In addition, the microlens substrate is configured by laminating a silicon-based resin which has good heat resistance and light resistance on the microlens side of the microlens substrate.

In addition, as described in JP-A-2008-197523, a microlens substrate which is configured by laminating an inorganic material of two layers or more on a microlens side is disclosed.

However, thickness of a substrate (neoceram glass) becomes thin, and stress is easily concentrated due to a shape between neighboring microlenses. Accordingly, there is a case in which a crack may occur at a portion. In addition, when a siloxane ingredient flows out from a silicon-based resin, and the siloxane ingredient reaches a liquid crystal layer through the crack, there is a problem in that display characteristics are influenced, and ghosting occurs.

In addition, in a method which is disclosed in JP-A-2008-197523, the microlens substrate is configured by laminating two or more layers of an inorganic material not including siloxane, however, there is a problem in that it takes time when forming the microlens substrate since the substrate is formed in multilayers, and accordingly, a productivity is decreased.

In addition, when attempting to raise lens performance by decreasing refractivity so as to be lower than that of glass using an inorganic film, there is a problem in that membrane gains a property of being easily porous, and there is a concern that moisture may get in a liquid crystal layer.

### SUMMARY

An advantage of some aspects of the invention is to realize following aspects and application examples.

### Application Example 1

A microlens substrate according to the application example includes a plurality of concave portions or convex portions which define each of curved surfaces of a plurality of microlenses; a non-silicon-based resin which is formed between concave portions or convex portions which are neighboring among the plurality of concave portions and convex portions; and a silicon-based resin which is formed so as to cover the non-silicon-based resin, and the plurality of concave portions or convex portions.

According to the application example, since the non-silicon-based resin is provided at the neighboring concave portions or the convex portions, even when a substance which has a negative influence on display characteristics flows out from the silicon-based resin, for example, and a crack occurs between the concave portions, or the convex portions which are neighboring at which stress easily occurs, it is possible to make the substance not be discharged to the outside through the crack due to a presence of the non-silicon-based resin. Accordingly, for example, when a liquid crystal device in which a microlens substrate is bonded is used, it is possible to prevent a substance causing a negative influence on display characteristics from reaching the liquid crystal device, and to prevent ghosting or the like which influences the display characteristics from occurring.

In addition, it is possible to suppress working hours or cost by being configured using a resin of two layers. In addition, it is possible to prevent moisture from getting in the resin by being configured including the resin of two layers.

### Application Example 2

In the microlens substrate according to the application example, a pair of substrates is provided so as to interpose the plurality of microlenses, and it is preferable that the plurality of microlenses be integrally formed on one of the pair of substrates.

According to the application example, since the microlens is integrally formed on the one substrate, even if a crack occurs when the substrate is relatively thin, it is possible to prevent a substance which influences display characteristics from being discharged to the outside through the crack, due to a non-silicon-based resin which is provided between the substrate and a silicon-based resin, even when the substance flows out from the silicon-based resin.

### Application Example 3

A microlens substrate according to the application example includes a plurality of concave portions which define each of curved surfaces of a plurality of microlenses; a non-silicon-based resin which is formed in the plurality of concave portions; and a silicon-based resin which is formed so as to cover the non-silicon-based resin.

According to the application example, since the non-silicon-based resin is provided in the concave portion, and the silicon-based resin is provided so as to cover those, even when a substance which has a negative influence on display characteristics flows out from the silicon-based resin, for example, and a crack occurs at a portion in the concave portion at which stress easily occurs, it is possible to make the substance not be discharged to the outside through the crack due to a presence of the non-silicon-based resin. Accordingly, it is possible to prevent the substance which has a negative influence on display characteristics from reaching the liquid crystal layer, and to prevent ghosting or the like which influences the display characteristics from occurring when a liquid crystal device in which a microlens substrate is bonded is used.

In addition, it is possible to suppress working hours or cost by being configured using a resin of two layers. In addition, it is possible to prevent moisture from getting in the resin by being configured including the resin of two layers.

### Application Example 4

In the microlens substrate according to the application example, a pair of substrates is provided so as to interpose the plurality of microlenses therebetween, and it is preferable that the plurality of microlenses be integrally formed on one of the pair of substrates.

According to the application example, since the microlens is integrally formed on the one substrate, even if a crack occurs when the substrate is relatively thin, it is possible to prevent a substance which influences display characteristics from being discharged to the outside through the crack, due to a non-silicon-based resin which is provided between the substrate and a silicon-based resin, even when the substance flows out from the silicon-based resin.

### Application Example 5

A manufacturing method of a microlens substrate according to the application example includes forming a concave portion or a convex portion which forms a plurality of concave portions or convex portions which define each of curved surfaces of a plurality of microlenses by performing an etching process on a substrate; forming a non-silicon-based resin between concave portions, or convex portions which are neighboring among the plurality of concave portions or the convex portions; and forming a silicon-based resin so as to cover the non-silicon-based resin, and the plurality of concave portions or the convex portions.

According to the application example, since the non-silicon-based resin is formed at the neighboring concave portions or the convex portions, even when a substance which has a negative influence on display characteristics flows out from the silicon-based resin, for example, and a crack occurs between the neighboring concave portions or convex portions at which stress easily occurs, it is possible to make the substance not be discharged to the outside through the crack due to the formed non-silicon-based resin. Accordingly, it is possible to prevent the substance which has a negative influence on display characteristics from reaching a liquid crystal layer, and to prevent ghosting or the like which influences the display characteristics from occurring when a liquid crystal device is used by bonding a microlens substrate thereto, for example.

In addition, it is possible to suppress working hours or cost by being configured using a resin of two layers. In addition, it is possible to prevent moisture from getting in the resin by being configured including the resin of two layers.

### Application Example 6

A manufacturing method of a microlens substrate according to the application example includes forming a concave portion which forms a plurality of concave portions which define each of curved surfaces of a plurality of microlenses by performing an etching process on a substrate; forming a non-silicon-based resin in the plurality of concave portions; and forming a silicon-based resin in which a silicon-based resin is formed on the entire substrate including the non-silicon-based resin.

According to the application example, since the non-silicon-based resin is provided in the concave portion, and the silicon-based resin is provided so as to cover those, even when a substance which has a negative influence on display characteristics flows out from the silicon-based resin, for example, and a crack occurs at a portion in the concave portion at which stress easily occurs, it is possible to make the substance not be discharged to the outside through the crack due to a presence of the non-silicon-based resin. Accordingly, it is possible to prevent the substance which has a negative influence on display characteristics from reaching a liquid crystal layer, and to prevent ghosting or the like from occurring which is caused by the substance influencing the display characteristics when a liquid crystal device is used by bonding a microlens substrate thereto.

In addition, it is possible to suppress working hours or cost by being configured using a resin of two layers. In addition, it is possible to prevent moisture from getting in the resin by being configured including the resin of two layers.

### Application Example 7

An electrooptic device according to the application example includes the above described microlens substrate.

According to the application example, since the above described microlens substrate is included, it is possible to provide an electrooptic device in which a utilization efficiency of light is increased.

### BRIEF DESCRIPTION OF THE DRAWINGS

The invention will be described with reference to the accompanying drawings, wherein like numbers reference like elements.

FIG. 1 is a perspective view which schematically illustrates a configuration of a liquid crystal device.

FIG. 2 is a perspective view which schematically illustrates a microlens substrate which configures the liquid crystal device.

FIG. 3 is an enlarged plan view which illustrates a part of a region of the microlens substrate by enlargement thereof.

FIG. 4 is a schematic cross-sectional view which is taken along line IV-IV of the microlens substrate illustrated in FIG. 3.

FIG. 5 is a plan view which schematically illustrates a configuration of the liquid crystal device from the microlens substrate side.

FIG. 6 is a schematic cross-sectional view which is taken along line VI-VI of the liquid crystal device illustrated in FIG. 5.

FIG. 7 is an equivalent circuit diagram which illustrates an electrical constitution of the liquid crystal device.

FIG. 8 is a cross-sectional view which schematically illustrates a structure of the liquid crystal device.

FIG. 9 is a cross-sectional view which schematically illustrates a state in which input light is condensed by the microlens substrate.

FIGS. 10A to 10E are cross-sectional views which schematically illustrate a manufacturing method of the microlens substrate.

FIG. 11 is a view which schematically illustrates a configuration of a projection type display device including the liquid crystal device.

FIG. 12 is a cross-sectional view which schematically illustrates a structure of a microlens substrate as a modification example.

FIG. 13 is a cross-sectional view which schematically illustrates a structure of a microlens substrate as another modification example.

FIG. 14 is a cross-sectional view which schematically illustrates a structure of a microlens substrate as still another modification example.

### DESCRIPTION OF EXEMPLARY EMBODIMENTS

Hereinafter, embodiments which embody the present invention will be described according to drawings. In addition, drawings which will be used are displayed by being appropriately enlarged or reduced so that a portion which will be described can be recognized.

In addition, hereinafter, when describing “on a substrate”, for example, this denotes a case of being arranged so as to come into contact with a substrate thereon, a case of being arranged through another component on the substrate, or a case in which a part is arranged so as to come into contact with the substrate thereon, and another part is arranged through another component.

According to the embodiment, an active matrix type liquid crystal device including a thin film transistor (TFT) as a switching element of pixels will be exemplified as an example of an electrooptic device. The liquid crystal device is a device which is preferably used as a light modulation element (liquid crystal light bulb) of a projection type display device (liquid crystal projector), for example.

### Configuration of Liquid Crystal Device, and Microlens Substrate

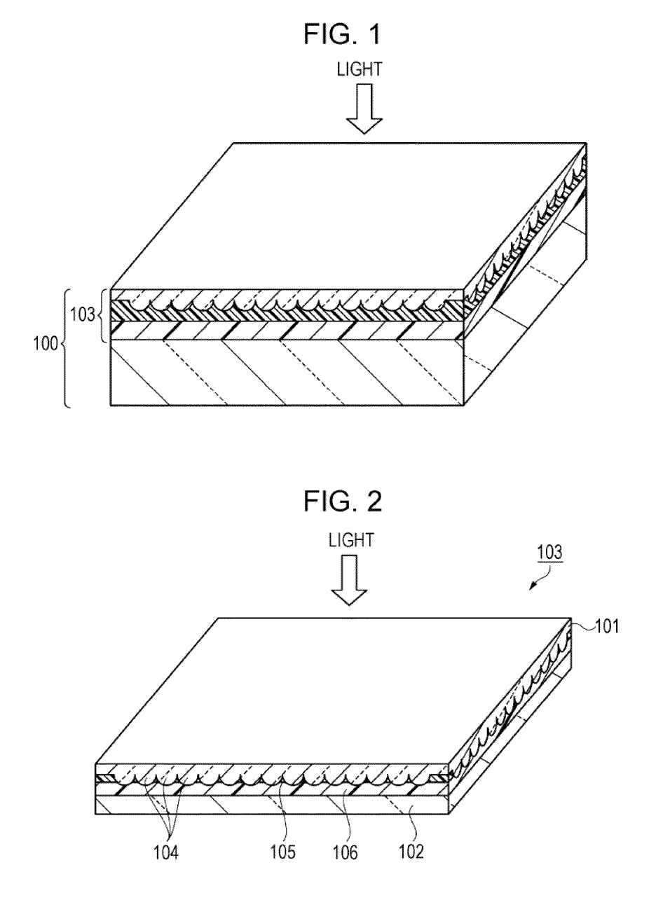

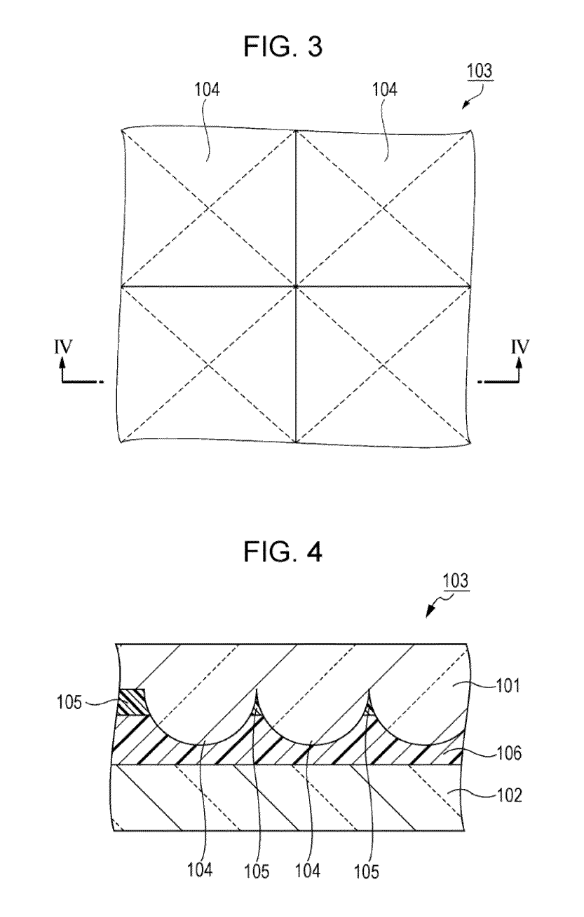

FIG. 1 is a perspective view which schematically illustrates a configuration of a liquid crystal device according to an example of an electrooptic device. FIG. 2 is a schematic perspective view of a microlens substrate which configures the liquid crystal device. FIG. 3 is an enlarged plan view which illustrates a part of a region of the microlens substrate by enlargement thereof. FIG. 4 is a schematic cross-sectional view which is taken along line IV-IV of the microlens substrate illustrated in FIG. 3. Hereinafter, configurations of the liquid crystal device and the microlens substrate will be described with reference to FIGS. 1 to 4.

As illustrated in FIG. 1, a liquid crystal device 100 according to the embodiment includes an element substrate 10 (refer to FIG. 6), and a microlens substrate 103 which configures a part of a counter substrate which is arranged on the element substrate 10.

As illustrated in FIG. 2, the microlens substrate 103 according to the embodiment includes, for example, a first substrate 101 (base substrate) which is formed of neoceram or the like, a plurality of microlenses 104 which are integrally formed with the first substrate 101, a non-silicon-based resin 105 which is provided between neighboring microlenses 104, a silicon-based resin 106 which is provided so as to cover the non-silicon-based resin 105 and the plurality of microlenses 104, and a second substrate 102 (cover substrate) which is formed of neoceram or the like which is provided so as to cover the silicon-based resin 106.

The first substrate 101 and the second substrate 102 are bonded to each other using the silicon-based resin 106, for example. In addition, the plurality of microlenses 104 are arranged in a planar manner in a matrix on the first substrate 101. In addition, a substrate which is arranged on the element substrate 10 side is referred to as the second substrate 102 (cover substrate). A substrate which is arranged on the side which is opposite to the second substrate 102 on the microlens substrate 103 is referred to as the first substrate 101 (base substrate). That is, light is input from the first substrate 101 between the pair of substrates (first substrate 101 and second substrate 102) which configure the microlens substrate 103.

As illustrated in FIGS. 3 and 4, a curved surface of each of the microlenses 104 is defined by neoceram and a silicon-based resin of which refractivity is different from each other, or neoceram and a non-silicon-based resin. In addition, each of the microlenses 104 is constructed as a convex lens (convex portion) which protrudes in a convex shape to the lower side in FIG. 4.

The microlens substrate 103 is arranged so that each of the microlenses 104 corresponds to each pixel of the element substrate 10 which will be described later, for example, when using thereof. Accordingly, input light which is input to each of the microlenses 104 is condensed toward each pixel in the element substrate 10 due to a refracting operation of each of the microlenses 104.

The first substrate 101 and the second substrate 102 have a large value of a refractive index, and the non-silicon-based resin 105 and the silicon-based resin 106 come after the first substrate and the second substrate when comparing the refractive index.

### Configuration of Liquid Crystal Device

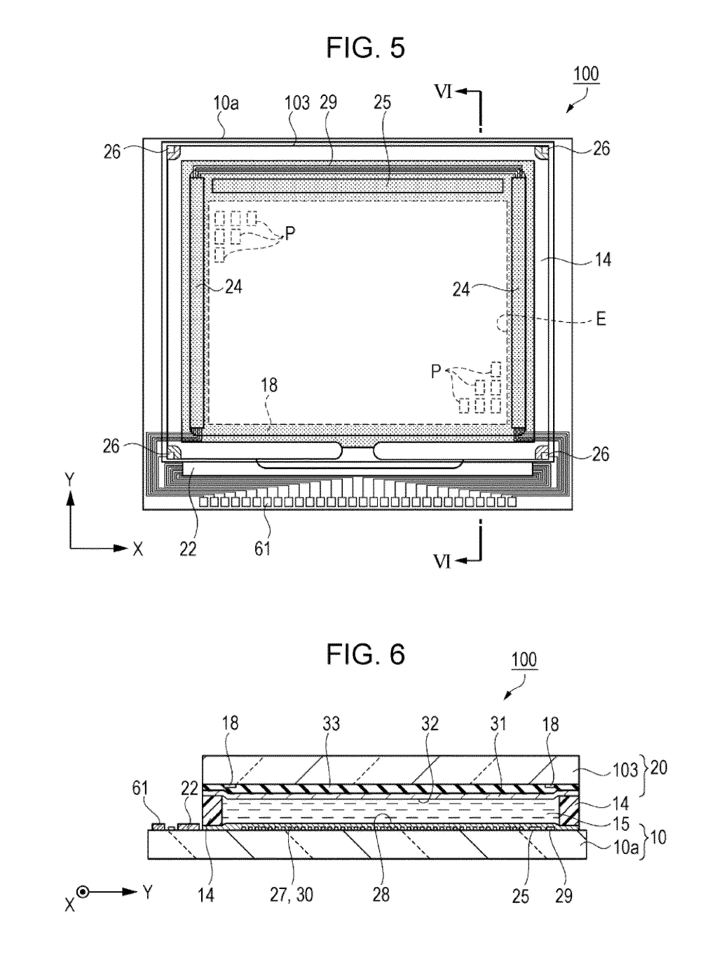

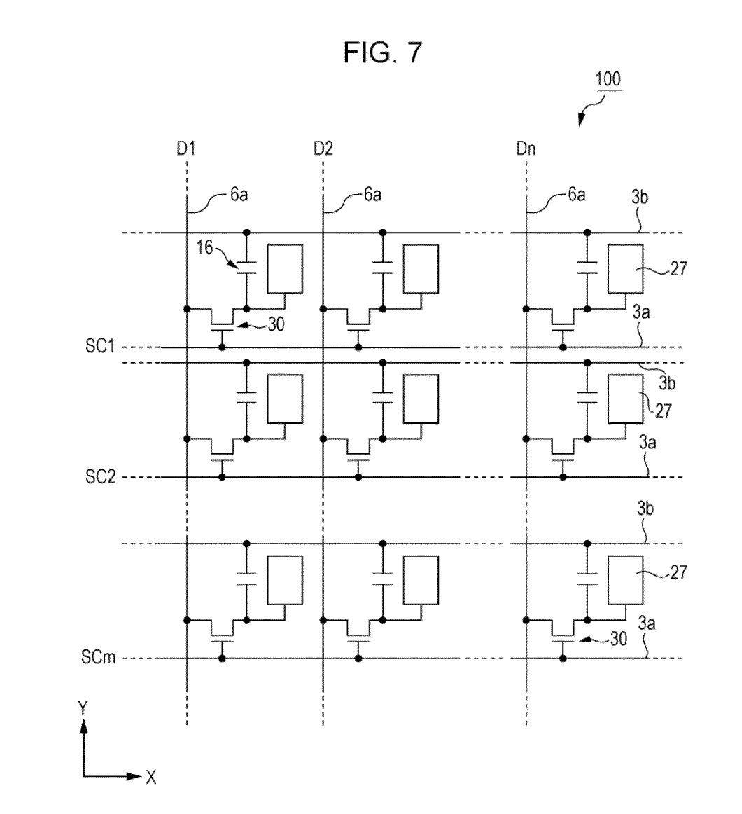

FIG. 5 is a plan view which schematically illustrates a configuration of the liquid crystal device from the microlens substrate side. FIG. 6 is a schematic cross-sectional view which is taken along line VI-VI illustrated in FIG. 5. FIG. 7 is an equivalent circuit diagram which illustrates an electrical configuration of the liquid crystal device. Hereinafter, the configuration of the liquid crystal device will be described with reference to FIGS. 5 to 7.

As illustrated in FIGS. 5 and 6, the liquid crystal device 100 according to the embodiment includes the element substrate 10 and the counter substrate 20 which are arranged in an opposing manner, and a liquid crystal layer 15 which is interposed between the pair of substrates. A first base material 10a configuring the element substrate 10, and a second base material 20a configuring the counter substrate 20 are formed by a transparent substrate such as a glass substrate, and a quartz substrate, for example.

The element substrate 10 is larger than the counter substrate 20, and both the substrates are bonded through a sealing material 14 which is arranged along the outer periphery of the counter substrate 20. A liquid crystal layer 15 is configured when liquid crystal having positive or negative dielectric anisotropy as an example of an electrooptic material is enclosed in a gap therebetween. As the sealing material 14, an adhesive, for example, such as a thermosetting epoxy resin, or an ultraviolet curable resin is adopted. A spacer (not shown) for maintaining a constant gap between the pair of substrates is mixed in the sealing material 14.

A pixel area E (display area) in which a plurality of pixels P are arranged is provided inside the sealing material 14. The pixel area E may include dummy pixels which are arranged so as to surround the plurality of pixels P, in addition to the plurality of pixels P which contribute to a display. In addition, though it is not shown in FIGS. 5 and 6, a light shielding unit (black matrix: BM) which respectively divides the plurality of pixels P in a planar manner in the pixel area E is provided in the counter substrate 20.

A data line driving circuit 22 is provided between the sealing material 14 which goes along one side of the element substrate 10 and the one side thereof. In addition, an inspection circuit 25 is provided between the sealing material 14 which goes along another one side which faces the one side and the pixel area E. In addition, a scanning line driving circuit 24 is provided between the sealing material 14 which goes along another two sides which are orthogonal to the one side, and face each other and the pixel area E. A plurality of wirings 29 which connect two scanning line driving circuits 24 are provided between the sealing material 14 which goes along another one side which faces the one side and the inspection circuit 25.

A light shielding unit 18 (parting unit) which is similarly a frame shape is provided inside the sealing material 14 which is arranged in a frame shape on the counter substrate 20 side. The light shielding unit 18 is formed of, for example, metal, metal oxide or the like having a light shielding property, and the inside of the light shielding unit 18 becomes the pixel area E including the plurality of pixels P. In addition, thought it is not shown in FIG. 5, the light shielding unit which divides the plurality of pixels P in a planar manner is also provided in the pixel area E.

The wiring which is connected to the data driving circuit 22 and the scanning line driving circuit 24 is connected to a plurality of external connection terminals 61 which are arranged along the one side. Hereinafter, descriptions will be made by setting the direction going along the one side to the X direction, and the direction going along the other two sides which are orthogonal to the one side, and face each other to the Y direction. In addition, the arrangement of the inspection circuit 25 is not limited to this, and the circuit may be provided between the sealing material 14 which goes along the data line driving circuit 22 and the pixel area E.

As illustrated in FIG. 6, a translucent pixel electrode 27 and a thin film transistor ((TFT), hereinafter referred to as “TFT 30”) which are provided in each pixel P, a signal wiring, and an alignment film 28 which covers thereof are formed on the surface of the first base material 10a on the liquid crystal layer 15 side.

In addition, a light shielding structure which prevents an unstable switching operation in the TFT 30 which is caused when light is input in a semiconductor layer is adopted. The element substrate 10 according to embodiments of the invention includes at least the pixel electrode 27, the TFT 30, the signal wiring, and the alignment film 28.

The light shielding unit 18, a planarization layer 33 which is formed so as to cover thereof, and a counter electrode 31 which is provided so as to cover the planarization layer 33, and an alignment film 32 which covers the counter electrode 31 are provided on the surface of the counter substrate 20 on the liquid crystal layer 15 side. The counter substrate 20 according to the embodiment of the invention includes at least the light shielding unit 18, the counter electrode 31, and the alignment film 32.

The light shielding unit 18 is provided in a position where the light shielding unit surrounds the pixel area E as illustrated in FIG. 5, and which is overlapped with the scanning line driving circuit 24, and the inspection circuit 25 (not shown) in a planar manner. In this manner the light shielding unit takes a role of shielding light which is input to peripheral circuits including these driving circuits from the counter substrate 20 side, and preventing malfunctions of the peripheral circuits due to light. In addition, the light shielding unit prevents unnecessary stray light from being input to the pixel area E, and secures high contrast in a display of the pixel area E.

The planarization layer 33 is formed of, for example, an inorganic material such as silicon oxide, and is provided so as to cover the light shielding unit 18 with optical transparency. As a formation method of such a planarization layer 33, for example, there is a film formation method using a plasma chemical vapor deposition (CVD) method, or the like.

The counter electrode 31 formed by a transparent conductive film, for example, such as indium tin oxide (ITO), covers the planarization layer 33, and is electrically connected to a wiring on the element substrate 10 side by vertical conduction units 26 which are provided on four corners of the counter substrate 20 as illustrated in FIG. 5.

The alignment film 28 which covers the pixel electrode 27, and the alignment film 32 which covers the counter electrode 31 are selected based on an optical design of the liquid crystal device 100. For example, there is an organic alignment film in which a film is formed using an organic material such as polyimide, and substantially horizontal aligning processing is performed with respect to liquid crystal molecules having positive dielectric anisotropy by rubbing the surface of the film, or an inorganic alignment film in which a film is formed using an inorganic material such as silicon oxide (SiOx), using a vapor growth method, and substantially vertical aligning processing is performed with respect to liquid crystal molecules having negative dielectric anisotropy. According to the embodiment, the above inorganic alignment film is adopted as the alignment films 28 and 32.

Such a liquid crystal device 100 is, for example, a transmission type, and an optical design of a normally white mode in which the pixel P becomes a bright display at the time of non-driving, or a normally black mode in which the pixel P becomes a dark display at the time of non-driving is adopted. Polarizing elements are used by being arranged on the input side and the output side of light, respectively, according to the optical design. According to the embodiment, the normally black mode is adopted.

As illustrated in FIG. 7, the liquid crystal device 100 includes at least a plurality of scanning lines 3a and a plurality of data lines 6a which are insulated from each other, and are orthogonal to each other in the pixel area E, and a capacitance line 3b. The direction in which the scanning line 3a extends is the X direction, and the direction in which the data line 6a extends is the Y direction.

The pixel electrode 27, the TFT 30, and a capacitative element 16 are provided in the scanning line 3a, the data line 6a, the capacitance line 3b, and in a region which is divided by these signal lines, and these configure a pixel circuit of the pixel P.

The scanning line 3a is electrically connected to a gate of the TFT 30, and the data line 6a is electrically connected to a source-drain region (source region) of the TFT 30 on the data line side. The pixel electrode 27 is electrically connected to a source-drain region (drain region) of the TFT 30 on the pixel electrode side.

The data line 6a is connected to the data line driving circuit 22 (refer to FIG. 5), and supplies image signals D1, D2, . . . , Dn which are supplied from the data line driving circuit 22 to the pixel P. The scanning line 3a is connected to the scanning line driving circuit 24 (refer to FIG. 5), and supplies scanning signals SC1, SC2, . . . , SCm supplied from the scanning line driving circuit 24 to each pixel P.

The image signals D1 to Dn which are supplied to the data lines 6a from the data line driving circuit 22 may be line-sequentially supplied in this order, and may be supplied for each group with respect to the plurality of data lines 6a which are neighboring each other. The scanning line driving circuit 24 supplies the scanning signals SC1 to SCm line-sequentially with respect to the scanning lines 3a at a predetermined timing pulsingly.

The liquid crystal device 100 has a configuration in which the image signals D1 to Dn which are supplied from the data lines 6a are written in the pixel electrode 27 at a predetermined timing when the TFTs 30 as switching elements are in an ON state for a certain period of time due to inputs of the scanning signals SC1 to SCm. In addition, the image signals D1 to Dn of a predetermined level which are written in the liquid crystal layer 15 through the pixel electrode 27 are maintained for a certain period of time between the pixel electrode 27 and the counter electrode 31 which is oppositely arranged through the liquid crystal layer 15.

In order to prevent the maintained image signals D1 to Dn from leaking, the capacitative element 16 is connected to a liquid crystal capacitance which is formed between the pixel electrode 27 and the counter electrode 31 in parallel. The capacitative element 16 is provided between the source-drain region of the TFT 30 on the pixel electrode side and the capacitance line 3b. The capacitative element 16 has a dielectric layer between two capacitance electrodes.

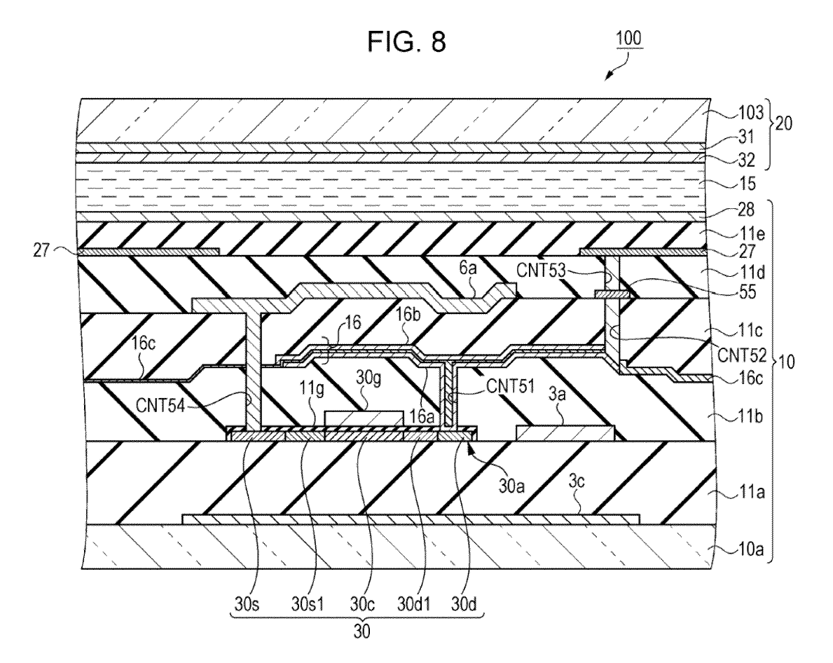

FIG. 8 is a cross-sectional view which schematically illustrates a structure of the liquid crystal device. Hereinafter, the structure of the liquid crystal device will be described with reference to FIG. 8. In addition, FIG. 8 illustrates a sectional positional relationship of each constituent element, and the constituent element is expressed using a scale which is clearly expressed.

As illustrated in FIG. 8, the liquid crystal device 100 includes one element substrate 10 between the pair of substrates, and a counter substrate 20 on the other side which is oppositely arranged thereto. As described above, the first base material 10a which configures the element substrate 10, and the second base material 20a which configures the counter substrate 20 are configured by quartz substrates or the like, for example.

A lower side light shielding film 3c which is formed of titanium (Ti), chromium (Cr), or the like is formed on the first base material 10a. The lower side light shielding film 3c is patterned in a lattice shape in a planar manner, and defines an opening region of each pixel. In addition, the lower side light shielding film 3c may function as a part of the scanning line 3a. A base insulation layer 11a which is formed of silicon oxide film or the like is formed on the first base material 10a and the lower side light shielding film 3c.

The TFT 30, the scanning line 3a, and the like are formed on the base insulation layer 11a. The TFT 30 has, for example, a Lightly Doped Drain (LDD) structure, and includes a semiconductor layer 30a which is formed of polysilicon or the like, a gate insulation film 11g which is formed on the semiconductor layer 30a and a gate electrode 30g which is formed of a polysilicon film or the like on a gate insulation film 11g. As described above, the scanning line 3a also functions as the gate electrode 30g.

The semiconductor layer 30a is formed as an N-type TFT 30, for example, when N-type impurity ions such as phosphorous (P) ions are injected thereinto. Specifically, the semiconductor layer 30a includes a channel region 30c, a data line side LDD region 30s1, a data line side source-drain region 30s, a pixel electrode side LDD region 30d1, and a pixel electrode side source-drain region 30d.

P-type impurity ions such as boron (B) are doped in the channel region 30c. N-type impurity ions such as phosphorous (P) ions are doped in other regions (30s1, 30s, 30d1, and 30d) excluding that. In this manner, the TFT 30 is formed as an N-type TFT.

First interlayer insulation layer 11b which is formed of a silicon oxide film or the like is formed on the gate electrode 30g, the base insulation layer 11a, and the scanning line 3a. The capacitative element 16 is provided on the first interlayer insulation layer 11b. Specifically, the capacitative element 16 is formed when a first capacitative element 16a as a pixel potential side capacitor electrode which is electrically connected to the pixel electrode side source-drain region 30d of the TFT 30 and the pixel electrode 27, and a part of the capacitance line 3b (second capacitance electrode 16b) as a fixed potential capacitance electrode are oppositely arranged through a dielectric film 16c.

The capacitance line 3b (second capacitance electrode 16b) is formed by a metal simple substance, an alloy, metal silicide, polyimide, a lamination thereof, and the like including, for example, at least one of high melting metals such as titanium (Ti), chromium (Cr), tungsten (W), tantalum (Ta), and molybdenum (Mo). Alternatively, it is also possible to form the capacitance line using an aluminum (Al) film.

The first capacitance electrode 16a is formed of, for example, a conductive polysilicon film, and functions as the pixel potential side capacitor electrode of the capacitative element 16. However, the first capacitance electrode 16a may be configured of a single layer film, or a multilayer film including metal, or an alloy, similarly to the capacitance line 3b. The first capacitance electrode 16a has a function of relaying and connecting the pixel electrode 27 and the pixel electrode side source-drain region 30d (drain region) of the TFT 30 through a contact hole CNT52, a relay layer 55, a contact hole CNT53, and a CNT51, in addition to the function as the pixel potential side capacitor electrode.

A data line 6a is formed on the capacitative element 16 through the second interlayer insulation layer 11c. The data line 6a is electrically connected to the data line side source-drain region 30s (source region) of the semiconductor layer 30a through the contact hole CNT54 which is open to the first interlayer insulation layer 11b and the second interlayer insulation layer 11c.

The pixel electrode 27 is formed on the data line 6a through a third interlayer insulation layer 11d. The pixel electrode 27 is electrically connected to the pixel electrode source-drain region 30d (drain region) of the semiconductor layer 30a when being connected to the first capacitor electrode 16a through the contact holes CNT52 and CNT53, and the relay layer 55 which are open to the second interlayer insulation layer 11c and the third interlayer insulation layer 11d. In addition, the pixel electrode 27 is formed by, for example, a transparent conductive film such as an ITO film.

The alignment film 28 in which an inorganic material such as silicon oxide (SiO₂) is performed with oblique vapor deposition is provided on the pixel electrode 27 and the third interlayer insulation layer 11d through a fourth interlayer insulation layer 11e. The liquid crystal layer 15 in which liquid crystal or the like is enclosed in a space which is surrounded with a sealing material 14 (refer to FIGS. 5 and 6) is provided on the alignment film 28.

On the other hand, the counter electrode 31 is provided on the second base material 20a on the entire surface thereof. The alignment film 32 on which the inorganic material such as silicon oxide (SiO₂) is obliquely deposited using vaporization is provided on the counter electrode 31 (lower side in FIG. 8). The counter electrode 31 is formed by, for example, the transparent conductive film such as the ITO film, similarly to the above described pixel electrode 27.

The liquid crystal layer 15 is in a predetermined aligned state due to the alignment films 28 and 32 in a state in which an electric field from the pixel electrode 27 is not applied thereto. The sealing material 14 is an adhesive which is formed of a photocurable resin, or a thermosetting resin, for example, for bonding the element substrate 10 and the counter substrate 20 at the periphery thereof, and a spacer such as a glass fiber, glass beads, or the like for maintaining a distance between both the substrates at a predetermined value is mixed therein.

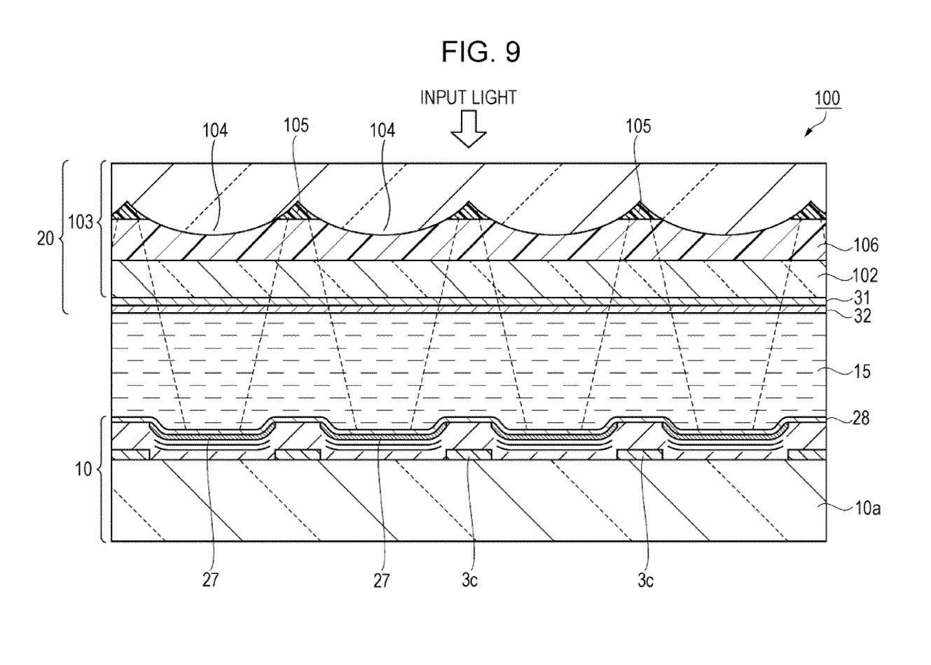

FIG. 9 is a cross-sectional view which schematically illustrates a state in which input light is condensed by a microlens substrate. Hereinafter, a function of light condensing in the microlens substrate will be described with reference to FIG. 9. In addition, in FIG. 9, a center of a lens of the microlens is arranged so as to be aligned in a center of each pixel.

As illustrated in FIG. 9, the microlens substrate 103 includes a plurality of microlenses 104 which condense light input from the upper part in the figure in the plurality of pixel electrodes 27, respectively, and are arranged in a matrix. In addition, the microlens substrate 103 is arranged as a part of the counter substrate 20. In addition, the ITO or the like may be provided between the microlens substrate 103 and the counter electrode 31.

By having such a configuration, according to the liquid crystal device 100 in the embodiment, the input light from the microlens substrate 103 is condensed on the plurality of pixel electrodes 27, respectively, by the plurality of microlenses 104. Accordingly, an effective opening rate in each pixel is increased compared to a case in which the microlens 104 is not present.

### Manufacturing Method of Microlens Substrate

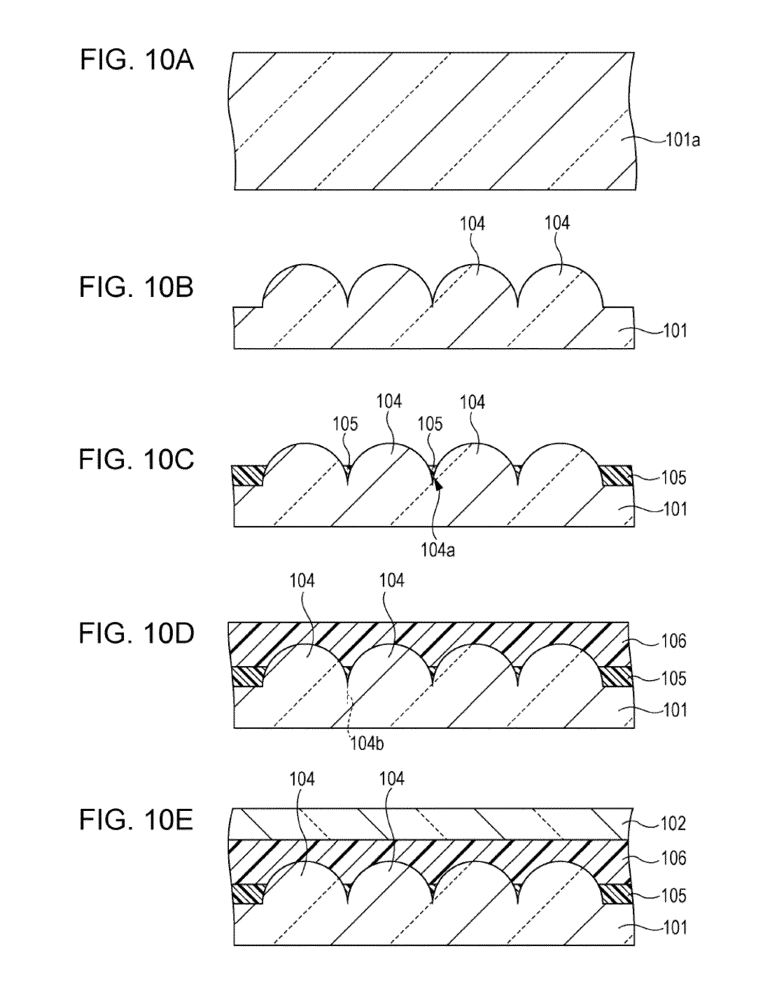

FIGS. 10A to 10E are cross-sectional views which schematically illustrate a manufacturing method of a microlens substrate. Hereinafter, the manufacturing method of the microlens substrate 103 will be described with reference to FIGS. 10A to 10E.

First, as illustrated in FIG. 10A, a transparent substrate 101a which is formed of neoceram or the like is prepared. For the thickness of the transparent substrate 101a, the thickness includes at least the thickness of the first substrate 101 as a cover substrate, and the height of the microlens 104.

Subsequently, in a process illustrated in FIG. 10B (concave or convex portion formation process), the microlens 104 is formed. Specifically, the microlens is formed using an etching technology. First, the surface of the transparent substrate 101a is etched from an opening portion of a mask, and a curved surface is formed. In the etching processing, it is possible to form a convex shaped microlens 104 by performing dry etching. A curved surface is formed for each microlens 104 in this stage.

Subsequently, in a process which is illustrated in FIG. 10C (non-silicon-based resin formation process), a non-silicon-based resin 105 is formed to a predetermined film thickness between neighboring microlenses 104. For the film formation method, as an application method, a spin coating method, an ink jet method, a falling-drop method, or the like is used, and the film formation is performed using the resin's own weight. The predetermined thickness is, for example, approximately a half of the height of the microlens 104. In addition, it is preferable that the film thickness be adjusted so that refractivity or the like be optimal. Thereafter, the non-silicon-based resin 105 is cured using ultraviolet light, heat, or the like.

In this manner, it is possible to adjust the refractivity (difference in refractivity) at an end portion 104a of the microlens 104 so as to be optically optimal, by forming the non-silicon-based resin 105 between the microlenses 104. Specifically, by making a difference in refractivity between the neoceram and the resin large, it is possible to make an influence of a shape of the microlens 104 less, and to condense light efficiently.

Subsequently, in a process which is illustrated in FIG. 10D (silicon-based resin formation process), the silicon-based resin 106 is formed so as to cover the microlens 104 and the non-silicon-based resin 105. The silicon-based resin 106 may be a thermosetting resin, or an ultraviolet curing resin.

In this manner, since the non-silicon-based resin 105 which is relatively weak in heat or light is covered with the silicon-based resin 106 which is relatively strong in heat or light, it is possible to prevent the non-silicon-based resin from being influenced in characteristics even when strong light or heat is applied from the outside.

On the other hand, even when siloxane bleeds out from the silicon-based resin 106, since the non-silicon-based resin 105 is interposed between the microlenses 104 into which a crack 104b easily gets and the silicon-based resin 106, it is possible to make siloxane not get in the liquid crystal layer 15. In this manner, it is possible to prevent display characteristics from being influenced.

Subsequently, in a process which is illustrated in FIG. 10E, the first substrate 101 on which the silicon-based resin 106 is formed, and the second substrate 102 (base substrate) which is formed of neoceram or the like are pressed and bonded in a vacuum. In addition, the silicon-based resin 106 is cured using ultraviolet light or heat.

In addition, the first substrate 101 on which the non-silicon-based resin 105 is formed, and the second substrate 102 on which the silicon-based resin 106 is formed may be bonded between the microlenses 104. In addition, the first substrate 101 and the second substrate 102 may be set to a desired thickness by a grinding process being performed thereon.

### Configuration of Electronic Apparatus

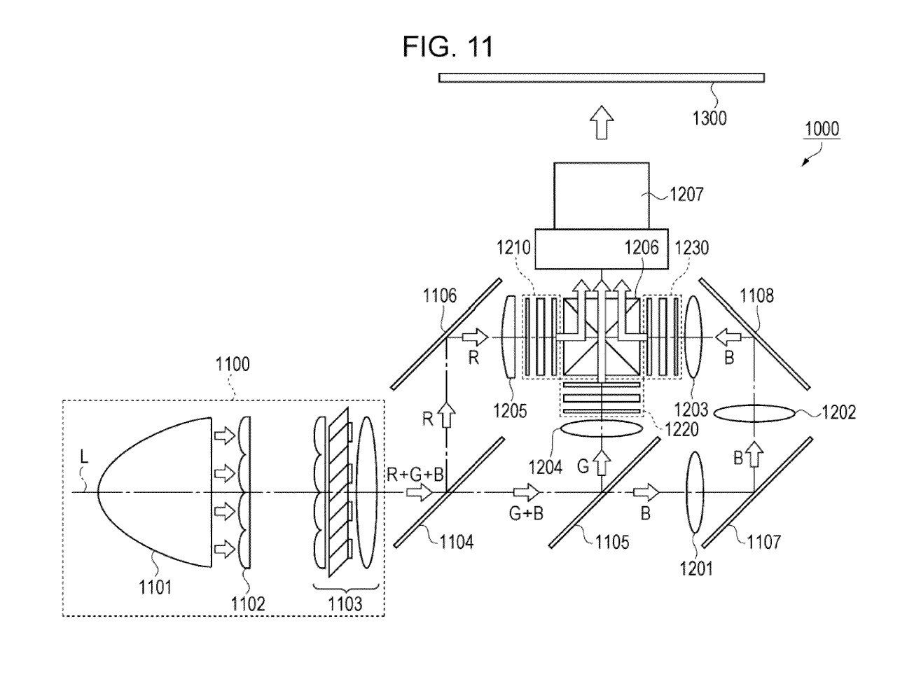

Subsequently, a projection type display device as an electronic apparatus according to the embodiment will be described with reference to FIG. 11. FIG. 11 is a schematic diagram which illustrates a configuration of a projection type display device including the above described liquid crystal device.

As illustrated in FIG. 11, a projection type display device 1000 according to the embodiment includes a polarization lighting system 1100, two dichroic mirrors 1104 and 1105 as light separation elements, three reflecting mirrors 1106, 1107, and 1108, five relay lenses 1201, 1202, 1203, 1204, and 1205, three transmissive liquid crystal light bulbs 1210, 1220, and 1230 as light modulation means, a cross dichroic prism 1206 as a light synthesizing element, and a projector lens 1207.

The polarization lighting system 1100 is schematically configured by a lamp unit 1101 as a light source which is formed by a white light source such as an ultrahigh pressure mercury lamp, or a halogen lamp, an integrator lens 1102, and a polarization conversion element 1103.

The dichroic mirror 1104 reflects red light (R), and transmits green light (G) and blue light (B) in a polarized luminous flux which is output from the polarization lighting system 1100. Another dichroic mirror 1105 reflects the green light (G) which passes through the dichroic mirror 1104, and transmits blue light (B).

The red light (R) which is reflected on the dichroic mirror 1104 is reflected on the reflecting mirror 1106, and is input to the liquid crystal light bulb 1210 through the relay lens 1205. The green light (G) which is reflected on the dichroic mirror 1105 is input to the liquid crystal light bulb 1220 through the relay lens 1204. The blue light (B) which passes through the dichroic mirror 1105 is input to the liquid crystal light bulb 1230 through a light guide system which is formed by the three relay lenses 1201, 1202, and 1203, and the two reflecting mirrors 1107 and 1108.

The liquid crystal light bulbs 1210, 1220, and 1230 are oppositely arranged, respectively, with respect to an input surface of each colored light of the cross dichroic prism 1206. Colored light beams which are input to the liquid crystal light bulbs 1210, 1220, and 1230 are modulated based on image information (image signal), and are output to the cross dichroic prism 1206.

Four right angle prisms are bonded in the prism, and a dielectric multilayer film which reflects red light, and a dielectric multilayer film which reflects blue light are formed in a cross inside the prism. Three colored light beams are synthesized, and light expressing a color image is synthesized by these dielectric multi-layers. The synthesized light is projected on a screen 1300 by the projector lens 1207 which is a projection optical system, and is displayed as an enlarged image.

The liquid crystal light bulb 1210 is a light bulb in which the above described liquid crystal device 100 is applied. The liquid crystal device 100 is arranged so that the device is placed with a gap between a pair of polarizing elements which are arranged in a crossed Nicol state in the input side and the output side of colored light. The same is applied to other liquid crystal light bulbs 1220 and 1230.

According to such a projection type display device 1000, since the liquid crystal device 100 in which ghosting or the like is suppressed is used as the liquid crystal light bulbs 1210, 1220, and 1230, it is possible to realize a high display quality.

In addition, as electronic apparatuses on which the liquid crystal device 100 is mounted, there are various electronic apparatuses such as a head up display, a smart phone, an electronic view finder (EVF), a mobile mini-projector, a mobile phone, a mobile computer, a digital camera, a digital video camera, a display, in-vehicle equipment, audio equipment, exposure equipment, a lighting system, and the like, in addition to the projection type display device 1000.

As described above, according to the microlens substrate 103 in the embodiment, the manufacturing method of the microlens substrate 103, and the liquid crystal device 100 including the microlens substrate 103, it is possible to obtain following effects.

(1) According to the microlens substrate 103 in the embodiment, and the manufacturing method of the microlens substrate 103, since the non-silicon-based resin 105 is provided between the neighboring microlenses 104, it is possible to make siloxane not be discharged to the outside through the crack 104b since the non-silicon-based resin 105 is present, even when, for example, siloxane which has a negative influence on display characteristics flows out from the silicon-based resin 106, and the crack 104b occurs between the neighboring microlenses 104 at which stress easily occurs. Accordingly, for example, when the liquid crystal device 100 including the microlens substrate 103 is used, it is possible to prevent siloxane which has a negative influence on display characteristics from reaching the liquid crystal layer 15, and to prevent ghosting or the like which is caused by the siloxane which influences display characteristics from occurring.

(2) According to the liquid crystal device 100 in the embodiment, it is possible to provide a liquid crystal device 100 in which a utilization efficiency of light is increased, since the liquid crystal device includes the above described microlens substrate 103 and the element substrate 10.

In addition, the embodiment of the invention is not limited to the above described embodiment, and can be appropriately changed without departing from the scope or spirit of the invention which is disclosed in claims and the whole specification, and is included in technical ranges of the embodiment of the invention. In addition, the embodiment can be executed in the following forms.

### Modification Example 1

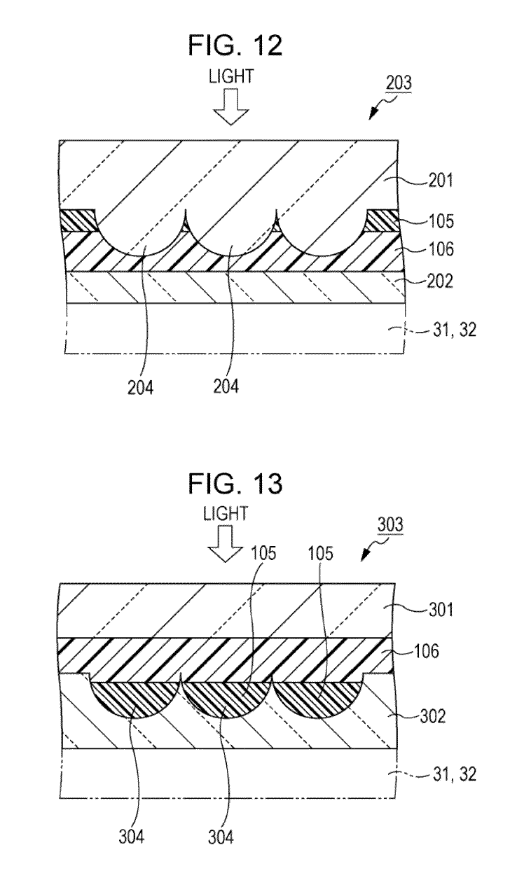

Configurations which are illustrated in FIGS. 12 to 14 may be possible without being limited to the above described configuration of the microlens substrate 103. FIGS. 12 to 14 are cross-sectional views which schematically illustrate structures of microlens substrates as modification examples.

A microlens substrate 203 which is illustrated in FIG. 12 is configured by a first substrate 201, a non-silicon-based resin 105, a silicon-based resin 106, and a second substrate 202 in order from the side which is opposite to a counter electrode 31. The non-silicon-based resin 105 is formed between microlenses 204 which are integrally formed with the first substrate 201. In addition, light is input from the first substrate 201 side. A manufacturing method of a microlens 204 is the same as that in the above described embodiment, and it is possible to form a convex shaped microlens 204 by performing etching on the first substrate 201.

A microlens substrate 303 which is illustrated in FIG. 13 is configured by a first substrate 301, a silicon-based resin 106, a non-silicon-based resin 105, and a second substrate 302 in order from the side which is opposite to a counter electrode 31. The non-silicon-based resin 105 is formed in a concave shaped microlens 304 (concave portion) which is integrally formed with the second substrate 302. In addition, the silicon-based resin 106 is formed so as to cover the non-silicon-based resin 105 and the first substrate 301. As a manufacturing method of the microlens, wet etching using etching solution in which hydrofluoric acid is mainly used is performed on the second substrate 302. It is possible to form the concave shaped microlens 304 by performing wet etching.

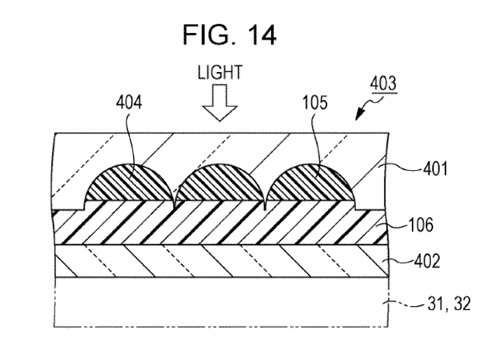

A microlens substrate 403 which is illustrated in FIG. 14 is configured by a first substrate 401, a non-silicon-based resin 105, a silicon-based resin 106, and a second substrate 402 in order from the side which is opposite to a counter electrode 31. The non-silicon-based resin 105 is formed in a concave shaped microlens 404 which is integrally formed with the first substrate 401. As a manufacturing method of the microlens 404, it is possible to form the concave shaped microlens 404 on the first substrate 401 by performing the wet etching processing, similarly to the above.

In the microlens substrates 203 and 403, since the second substrates 202 and 402 have flat shapes, it is also possible to omit the second substrates 202 and 402 by making the silicon-based resin 106 thick. In addition, the manufacturing method of the microlens substrates 203, 303, and 403 is almost the same as that in the above described embodiment.

In the microlens substrates 303 and 403, since the non-silicon-based resin 105 is provided in the concave shaped microlenses 304 and 404, and the silicon-based resin 106 is provided so as to cover thereof, even when siloxane which has a negative influence on display characteristics flows out from the silicon-based resin 106, for example, and a crack occurs at a portion in the concave portion at which stress easily occurs, it is possible to make siloxane not be discharged to the outside through the crack due to a presence of the non-silicon-based resin 105. Accordingly, it is possible to prevent siloxane which has a negative influence on display characteristics from reaching the liquid crystal layer 15, and to prevent ghosting or the like from occurring which is caused by siloxane which influences the display characteristics when the liquid crystal device 100 is used by including the microlens substrates 303 and 403 therein.

In addition, in the microlens substrates 103, 203, 303, and 403, it is possible to optimize bending of light by adjusting the thickness and refractivity of the non-silicon-based resin 105 or the silicon-based resin 106. For example, it is possible to increase transmittance of a panel, for example, even when the microlens has a simple hemispheric shape.

### Modification Example 2

As described above, in the first substrate 101 and the second substrate 102, a material thereof is not limited to neoceram, and, for example, glass or quartz may be also used.

The entire disclosure of Japanese Patent Application No. 2012-170880, filed Aug. 1, 2012 is expressly incorporated by reference herein.

What is claimed is:

1. A lens substrate comprising:
a plurality of concave portions or convex portions which define each of curved surfaces of a plurality of lenses;
a non-silicon-based resin which is formed between concave portions or convex portions which are neighboring among the plurality of concave portions and convex portions; and
a silicon-based resin which is formed so as to cover the non-silicon-based resin, and the plurality of concave portions or convex portions.

2. The lens substrate according to claim 1,
wherein a pair of substrates is provided so as to interpose the plurality of lenses, and
wherein the plurality of lenses are integrally formed on one of the pair of substrates.

3. A lens substrate comprising:
a plurality of concave portions which define each of curved surfaces of a plurality of lenses;
a non-silicon-based resin which is formed in the plurality of concave portions; and
a silicon-based resin which is formed so as to cover the non-silicon-based resin.

4. The lens substrate according to claim 3,
wherein a pair of substrates is provided so as to interpose the plurality of lenses therebetween, and
wherein the plurality of lenses are integrally formed on one of the pair of substrates.

5. An electrooptic device comprising the lens substrate according to claim 1.
